(19) United States
(12) Patent Application Publication
(10) Pub. No.: US 2007/0211339 A1
(43) Pub. Date: Sep. 13, 2007

(54) Polarized light splitting device and method for manufacturing the same

(75) Inventor: Daiki Furusato, Minowa-machi (JP)

Correspondence Address: OLIFF & BERRIDGE, PLC, P.O. BOX 19928, ALEXANDRIA, VA, 22320, US

(73) Assignee: EPSON TOYOCOM CORPORATION, TOKYO (JP)

(21) Appl. No.: 11/714,234

(22) Filed: Mar. 6, 2007

(30) Foreign Application Priority Data
Mar. 13, 2006 (JP) 2006-067572
Feb. 13, 2007 (JP) 2007-031608

(51) Int. Cl. G02B 27/28

(52) U.S. Cl. 359/495; 359/483

(57) ABSTRACT

The present invention provides a polarized light splitting device including two right triangular prisms bonded to each other at inclined surfaces thereof via a polarized light splitting coating disposed between the inclined surfaces, in which the polarized light splitting coating includes a first polarized light splitting coating layer formed by alternately laminating a first low refractive index coating made of a first low refractive index material having a compressive stress and a high refractive index coating made of a high refractive index material and a second polarized light splitting coating layer formed by alternately laminating a second low refractive index coating made of a second low refractive index material having a tensile stress and the high refractive index coating.

### BACKGROUND

1. Technical Field

The present invention relates to a polarized light splitting device and a method for manufacturing the same. In particular, the invention is suitable for use in an optical pickup of an optical disc recording and reproducing apparatus.

2. Related Art

FIGS. 7A and 7B illustrate a structure of a known polarized light beam splitter (polarized light splitting device) used in an optical pickup of a recording and reproducing apparatus for an optical disc or a magneto-optical disc and a method for using the same.

A polarized light beam splitter 100 shown in FIG. 7A has a cubic structure in which two triangular prisms 101 and 102 are bonded to each other via a polarized light splitting coating 110 disposed therebetween. The polarized light beam splitter 100, for example, transmits a predetermined polarized light component (P-polarized light) and reflects a light component (S-polarized light) other than that. Thus, when the polarized light splitting device 100 having such a structure is used in an optical pickup, polarizations will be as follows. As shown in FIG. 7B, among laser light beams from a laser diode 121 as an optical source, the P-polarized light component transmits through the polarized light splitting coating 110 and then is converted into a circularly polarized light by a quarter wavelength plate 122 to be irradiated to a disc surface of an optical disc 123. Since a rotation direction of a circularly polarized light reflected on the disc surface becomes opposite to a rotation direction of the incident circularly polarized light, the light reflected on the disc surface thereof is converted into S-polarized light by the quarter wavelength plate 122. Then, the S-polarized light is reflected on the polarized light splitting coating 110 and received by a light receiving device 124.

As related art documents, a first example thereof discloses a technique relating to a method for manufacturing an optical device subjected to mirror surface finishing without performing complicated mirror surface finishing after a dividing process. A second example of related art discloses an optical device with higher light use efficiency.

In addition, a third example thereof discloses an optical multilayer coating filter that can prevent optical strain by further reducing a width of substrate warpage due to a stress of a dielectric coating laminated on a transparent substrate and a manufacturing method thereof. Furthermore, an optical multilayer coating filter disclosed in a fourth example thereof can reduce the stress and warpage of a dielectric multilayer coating more than known optical multilayer coating filters even in a case of using dielectric multilayer coatings equal to or more than 40 layers.

JP-A-2000-143264 is the first example of related art.

Japanese Patent No. 3486516 is the second example of related art.

JP-A-2005-43755 is the third example of related art.

JP-A-07-209516 is the fourth example of related art.

On the other hand, regarding an optical pickup used in a recording and reproducing apparatus for an optical disk or the like, there has been a recent demand for being suitable for a plurality kinds of different optical discs such as blue laser disc products as typified by Blu-ray Disc using a blue-violet laser of 405 nm and HD-DVD, in addition to the CD of the 780 nm band and the DVD of the 660 nm band. Accordingly, even in a polarized light beam splitter used in an optical pickup, a broad spectrum of wavelength of light has been demanded. The polarized light splitting coating 110 shown in FIG. 8 meets the demand for such a broad spectrum.

The polarized light splitting coating 110 in the figure is formed, on a glass plate 113 forming the prism 102, by alternately laminating a plurality of lanthan-aluminate coatings 111 made of a mixed oxide of lanthan (La) and aluminum (Al) which are high refractive index materials and a plurality of magnesium fluoride (MgF₂) coatings 112 which is a low refractive index material.

However, in the polarized light beam splitter 100 having the above polarized light splitting coating 110 formed therein, as shown in FIG. 9, there is a problem that the polarized light splitting coating 110 is separated from the prism 102 or a crack of the coating 110 occurs at an interface therebetween, whereby optical characteristics are deteriorated.

Thus, inventor of the present invention keenly examined factors causing the above problems and found out that such problems stem from a coating stress of each MgF₂ coating 112.

FIG. 10 illustrates effect of the above-mentioned stress in the polarized light splitting coating 110.

In this figure, reference symbol F1 represents a force pulling or pushing the coating by a modulus of elasticity of the glass plate 113 forming the prism 102. F1 is inherent in a glass material of the glass plate 113. Additionally, in the present specification, F1 is referred to as a “glass elastic force”.

Furthermore, reference symbol F2 represents a coating stress of each lanthan-aluminate coating 111, F3 represents a coating stress of each MgF₂ coating 112 and F0 represents an overall stress, respectively. Directions and magnitudes of the coating stresses vary with conditions of deposition. Therefore, the directions and magnitudes of the coating stresses F2 and F3 in the invention have been obtained by actually depositing the lanthan-aluminate coatings 111 and the MgF1 coatings 112. As a deposition method, in addition to electronic beam (hereinafter referred to as “EB”) deposition and sputtering deposition, there are used ion plating and assist deposition such as ion-assisted deposition. A designer appropriately selects a deposition method based on requirement specifications for a polarized light splitting device.

Furthermore, the ion-assisted technique is characterized in that deposition of a coating material on a surface of a glass plate by ion acceleration can increase adhesiveness between the coating material and the glass plate.

In this case, the coating stress F2 of the lanthan-aluminate coating 111 acts in a tensile direction with respect to the glass plate 113 and the coating stress F3 of the MgF₂ coating 112 also acts in the tensile direction with respect thereto. Additionally, in a comparison of magnitudes between the coating stresses F2 and F3, for example, the coating stress F2 of the lanthan-aluminate coating 111 is approximately 0.15 GPa, whereas the coating stress F3 of the MgF₂ coating 112 is approximately 0.31 GPa. In total, a coating stress of approximately 0.46 GPa acts in the tensile direction with respect thereto. As a result, it has been found out that, even with addition of the elastic force F1 of the glass plate 113, the overall force F0 of the coating acts in the tensile direction with respect thereto, whereby a separation or crack of the polarized light splitting coating 110 will occur at the interface between the glass plate 113 and the polarized light splitting coating 110.

### SUMMARY

Therefore, the invention has been made to solve the above problems. An advantage of the present invention is to provide a polarized light splitting device capable of preventing a separation or crack of a polarized light splitting coating at an interface between the polarized light splitting coating and a glass plate, as well as a method for manufacturing the polarized light splitting device.

In order to achieve the above advantage, according to a first aspect of the invention, there is provided a polarized light splitting device including two right triangular prisms bonded to each other at inclined surfaces thereof via a polarized light splitting coating disposed between the inclined surfaces. In this device, the polarized light splitting coating includes a first polarized light splitting coating layer formed by alternately laminating a first low refractive index coating made of a first low refractive index material having a compressive stress and a high refractive index coating made of a high refractive index material having a compressive stress and a second polarized light splitting coating layer formed by alternately laminating a second low refractive index coating made of a second low refractive index material having a tensile stress and the high refractive index coating. In this aspect, the polarized light splitting coating is comprised of the first polarized light splitting coating layer formed by the alternate lamination of the first low refractive index coating having the compressive stress and the high refractive index coating and the second polarized light splitting coating layer formed by the alternate lamination of the second low refractive index coating having the tensile stress and the high refractive index coating. This structure allows a coating stress of the first polarized light splitting coating layer acting in the tensile direction with respect to the prism to be cancelled by a coating stress of the second polarized light splitting coating layer acting in the compressive direction with respect to the prism. Consequently, neither separation nor crack of the polarized light splitting coating occurs at an interface between the prism and the polarized light splitting coating. Thus, deterioration of optical characteristics of the polarized light splitting device can be prevented.

Furthermore, in the above polarized light splitting device, the first low refractive index coating may be an SiO₂ coating and the second low refractive index coating may be an MgF₂ coating. In this manner, a tensile stress of the MgF₂ coating can be cancelled by a compressive stress of the SiO₂ coating. Accordingly, neither separation nor crack of the polarized light splitting coating occurs at the interface between the prism and the polarized light splitting coating. This can reliably prevent the deterioration of optical characteristics of the polarized light splitting device.

According to a second aspect of the invention, there is provided a method for manufacturing a polarized light splitting device including two right triangular prisms bonded to each other at inclined surfaces thereof via a polarized light splitting coating disposed between the inclined surfaces. The method includes preparing a plurality of rectangular glass plates, each having on its upper surface a polarized light splitting coating that includes a first polarized light splitting coating layer formed by alternately laminating a first low refractive index coating made of a first low refractive index material having a compressive stress and a high refractive index coating made of a high refractive index material having a compressive stress and a second polarized light splitting coating layer formed by alternately laminating a second low refractive index coating made of a second low refractive index material having a tensile stress and the high refractive index coating; forming a multilayer structure by alternately laminating the plurality of glass plates via an adhesive material in a stepped configuration by sequentially displacing surface-direction positions of the glass plates such that an angle between a plane connecting ends of the glass plates and the glass plate surfaces is an inclined angle of approximately 45 degrees; cutting the multilayer structure integrated in the multilayer structure formation process into a plurality of multilayer segments at a plurality of parallel cut surfaces having a predetermined pitch along the inclined angle of 45 degrees; performing mirror surface finishing on the cut surfaces of the multilayer segments formed in the cutting process; temporarily bonding the multilayer segments to each other with a temporarily bonding material by laminating them in a consistent manner such that the mirror surfaces of the multilayer segments obtained by segmentation in the cutting process are opposing to each other; dividing the plurality of multilayer segments temporarily bonded with the temporarily bonding material by cutting the multilayer segments at cut surfaces orthogonal to the cut surfaces used in the cutting process to form temporarily bonded multilayer structures; performing mirror surface finishing on the cut surfaces of the temporarily bonded multilayer structures obtained in the dividing process; forming a connected structure comprised of a plurality of polarized light splitting devices which are connected in series via the temporarily bonding material by cutting each of the temporarily bonded multilayer structures in a direction orthogonal to the cut surfaces at equal intervals; and separating the connected structure comprised of the polarized light splitting devices into individual cubic polarized light splitting devices by dissolving and removing the temporarily bonding material forming the connected structure. In the method according to the second aspect, neither separation nor crack of the polarized light splitting coating occurs at the interface between the prism and the polarized light splitting coating. Therefore, yielding of the polarized light splitting device can be improved.

### BRIEF DESCRIPTION OF THE DRAWINGS

The invention will be described with reference to the accompanying drawings, wherein like numbers reference like elements.

FIG. 1 shows a structure of a polarized light beam splitter according to an embodiment of the invention.

FIG. 2 schematically shows a structure of a polarized light splitting coating included in the polarized light beam splitter according to the embodiment of the invention.

FIG. 3 shows effect of a coating stress in the polarized light splitting coating according to the embodiment of the invention.

FIGS. 4A to 4D show process views for illustrating a method for manufacturing the polarized light beam splitter according to the embodiment of the invention.

FIGS. 5A to 5G also show the process views for illustrating the manufacturing method thereof.

FIG. 6 shows a flowchart of the manufacturing processes shown in FIGS. 4A to 4D and FIGS. 5A to 5G.

FIGS. 7A and 7B illustrate a structure of a known polarized light beam splitter and a method for using the same.

FIG. 8 schematically shows a structure of a polarized light splitting coating used in the polarized light beam splitter shown in FIGS. 7A and 7B.

FIG. 9 illustrates a problem of the known polarized light beam splitter.

FIG. 10 illustrates effect of a coating stress in the known polarized light splitting coating.

### DESCRIPTION OF EXEMPLARY EMBODIMENTS

Hereinafter, embodiment of the invention will be described.

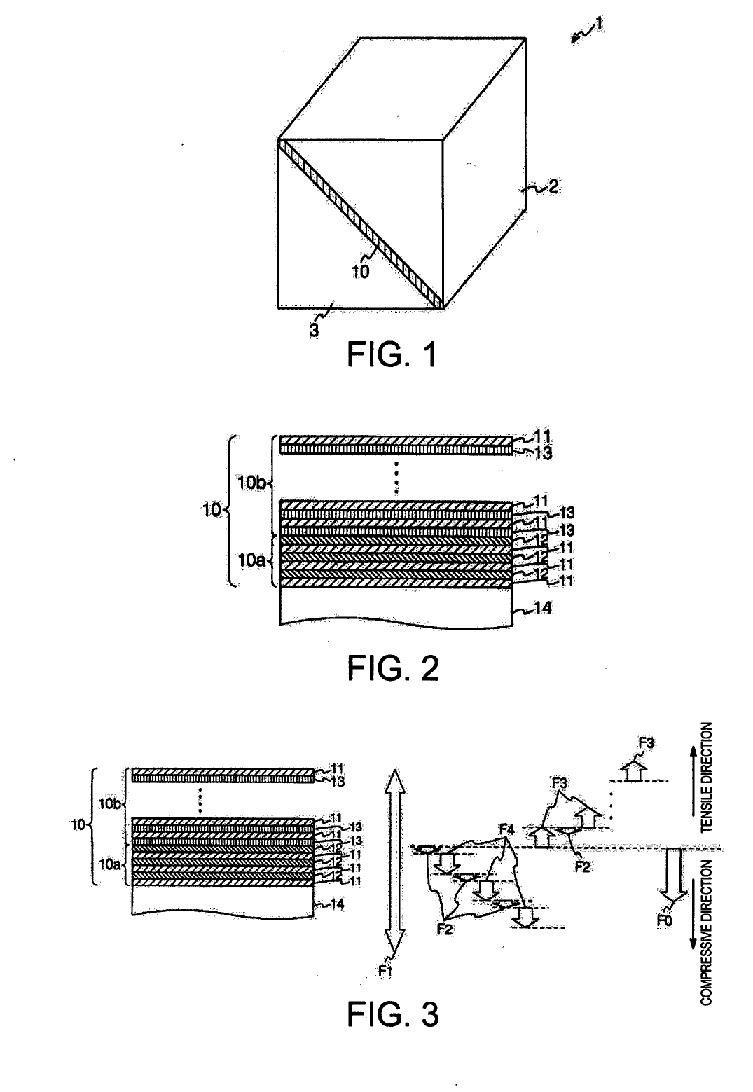

FIG. 1 illustrates a structure of a polarized light splitting device according to an embodiment of the invention.

As shown in FIG. 1, a polarized light beam splitter (polarized light splitting device) 1 employed in the embodiment of the invention is cubically formed by bonding two right triangular prisms 2 and 3 to each other via a polarized light splitting coating 10 disposed therebetween. For example, the polarized light beam splitter 1 has a function of transmitting a predetermined polarized light component (P-polarized light) and reflecting a polarized light component (S-polarized light) other than that.

The polarized light splitting coating 10 has properties of selectively transmitting one of the S-polarized light and the P-polarized light and selectively reflecting the other of them. The polarized light splitting coating 10 will be further described below.

In addition, the polarized light beam splitter 1 having the above structure is characterized in that the polarized light splitting coating 10 is formed in a manner as below.

FIG. 2 schematically shows a structure of the polarized light splitting coating 10 of the polarized light beam splitter 1 according to the embodiment of the invention.

As shown in FIG. 2, the polarized light splitting coating 10 in the polarized light beam splitter 1 according to the embodiment includes, on a glass plate 14 forming a prism 3, a first polarized light splitting coating layer 10a formed by alternately laminating a plurality of lanthan-titanate coatings (high refractive index coatings) 11 made of a mixed oxide of lanthan (La) and titanium (Ti) as a high refractive index material and a plurality of SiO₂ coatings (first low refractive index coating) 12 made of silicon dioxide (SiO₂) as a first low refractive index material. In addition, the polarized light beam splitter 10 has also a second polarized light splitting coating layer 10b formed by alternately laminating a plurality of MgF₂ coatings (second low refractive index coatings) 13 made of magnesium fluoride (MgF₂) as a second low refractive index material and the plurality of lanthan-titanate coatings (high refractive index coatings) 11.

In this embodiment, a lanthanum titanate coating is exemplified as the high refractive index coating 11 to explain. However, it is possible to use a variety of high refractive index coatings such as a lanthanum aluminate coating is made of a composite oxide of La and aluminum (Al).

And SiO₂ coating is exemplified as the first law refractive index coating 12 to explain. However, it is possible to use a variety of law refractive index coatings such as Ta₂O₅ coatings, TiO₂ coatings, Nb₂O₅ coating and Al₂O₃ coatings.

FIG. 3 illustrates effects of a coating stress of the polarized light splitting coating 10. In FIG. 3, reference symbol F1 represents a glass elastic force of each of the glass plates 14 forming the prism 3; F2 represents a coating stress of each of the lanthan-titanate coatings 11; F3 represents a coating stress of each of the MgF₂ coatings 13; F4 represents a coating stress of each of the SiO₂ coatings 12; and F0 represents an overall stress of them, respectively. The direction and magnitude of a coating stress are greatly influenced by the conditions of deposition. Accordingly, the directions and magnitudes of the coating stresses F2, F3 and F4 have been obtained by actually forming the lanthan-titanate coatings 11, the SiO₂ coatings 12 and the MgF₂ coatings 13 on the glass plate 14 by using EB deposition, sputtering deposition, assist deposition or the like.

In this case, the coating stress F2 of the lanthan-titanate coating 11 and the coating stress F4 of the SiO₂ coating 12 act in a compressive direction with respect to the glass plate 14, whereas the coating stress F3 of the MgF₂ coating 13 acts in a tensile direction with respect thereto.

Additionally, when a comparison of magnitudes is made between the coating stresses F2 and F4, the coating stress F2 of the lanthan-titanate coating 11 is 0.05 GPa and the coating stress F4 of the SiO₂ coating 12 is 0.3 GPa, for example. Additionally, the coating stress F3 of the MgF₂ coating 13 is 0.31 GPa. As a result, in a comparison of the coating stresses F2, F3 and F4, the coating stress F3 of the MgF₂ coating 13 is approximately equal to the coating stress F4 of the SiO₂ coating 12, whereas the coating stress F2 of the lanthan-titanate coating 11 is significantly smaller that the coating stress F3 of the MgF₂ coating 13 and the coating stress F4 of the SiO₂ coating 12, so that F2 can be regarded as a stress at a negligible level.

Thus, in the embodiment of the invention, the first polarized light splitting coating layer 10a is formed that is comprised of the SiO₂ coatings 12 and lanthan-titanate coatings 11 having the compressive stress with respect to the glass plate 14, with the second polarized light splitting coating layer 10b comprised of the MgF₂ coatings 13 and lanthan-titanate coatings 11 having the tensile stress with respect to the glass plate 14. This allows the coating stress F3 of the MgF₂ coating 13 acting in the tensile direction to be cancelled by the coating stress F4 of the SiO₂ coating 12 acting in the compressive direction. Consequently, the number of the layered SiO₂ coatings 12 is set to be approximately equal to that of the layered MgF₂ coatings 13 or the number of the layered MgF₂ coatings 13 is set to be smaller than that of the layered SiO₂ coatings 12.

In this manner, the overall stress F0 of the polarized light splitting coating 10 in the embodiment can be maintained in an equilibrium state or can be made to act in the compressive direction with respect to the glass plate 14. As a result, a separation and a crack of the polarized light splitting coating 10 can be prevented at the interface between the glass plate 14 and the polarized light splitting coating 10.

The layer number of the MgF₂ coatings 13 of the second polarized light splitting coating layer 10b and the layer number of the SiO₂ coatings 12 of the first polarized light splitting coating layer 10a can be properly determined in consideration of required optical characteristics, coating stresses of the MgF₂ coatings 13 and the SiO₂ coatings 12, the glass elastic force of the glass plate 14 forming the prism 3 and the like.

Furthermore, regarding the order of processes for manufacturing the first and second polarized light splitting coating layers 10a and 10b in the polarized light splitting coating 10, it is preferable to form the first polarized light splitting coating layer 10a made of the coating material having the compressive stress on the glass plate 14 side, so that adhesiveness at the interface between the glass plate 14 and the polarized light splitting coating layer can be further improved.

Next, a description will be given of a manufacturing method of the polarized light beam splitter according to the embodiment of the invention.

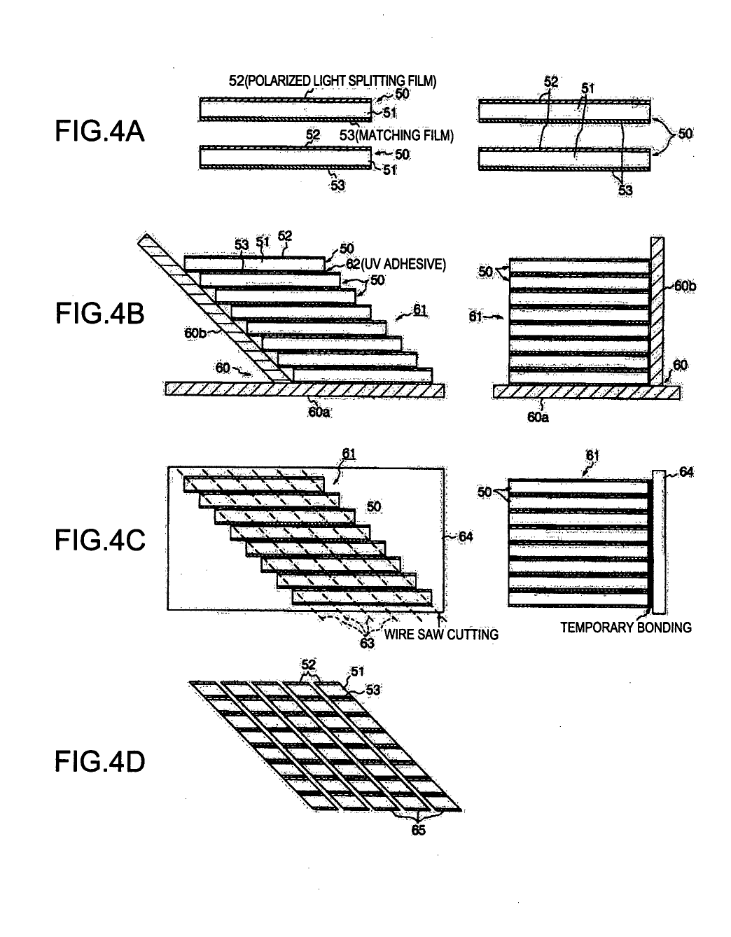

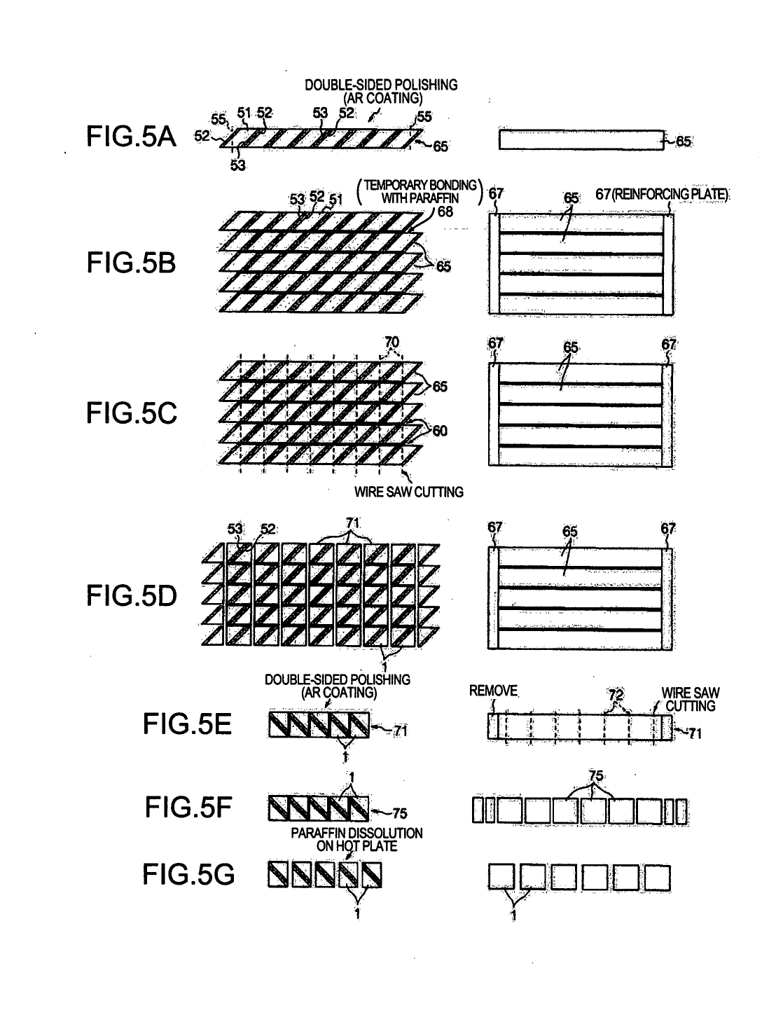

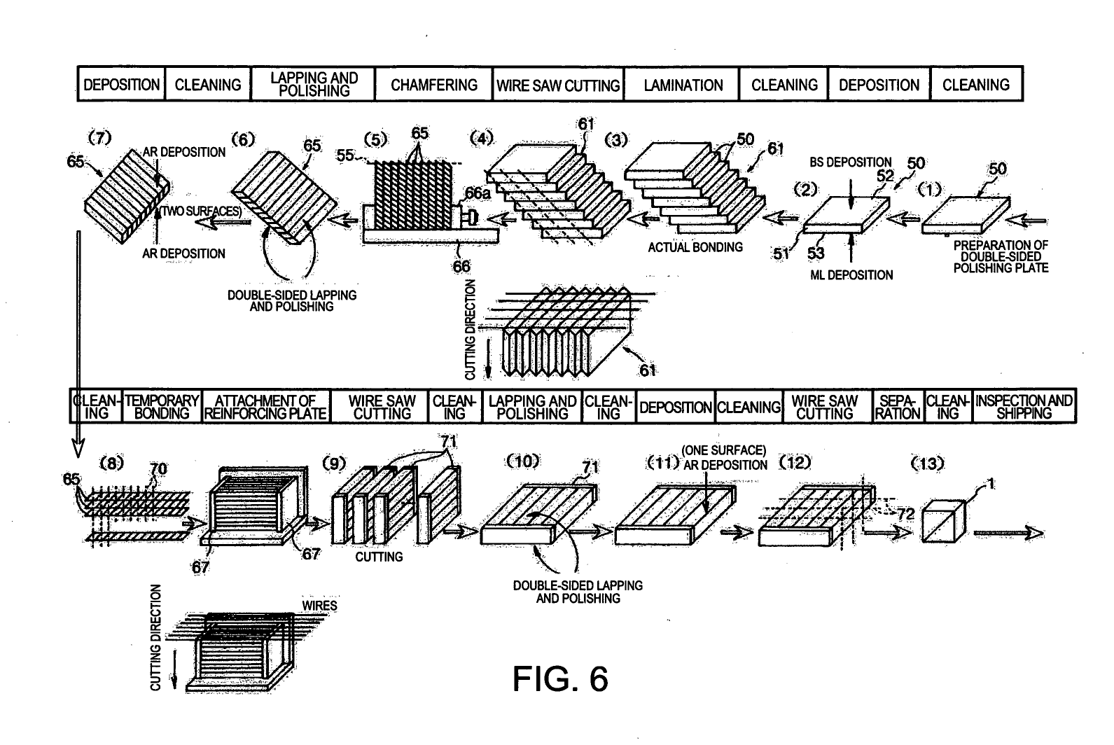

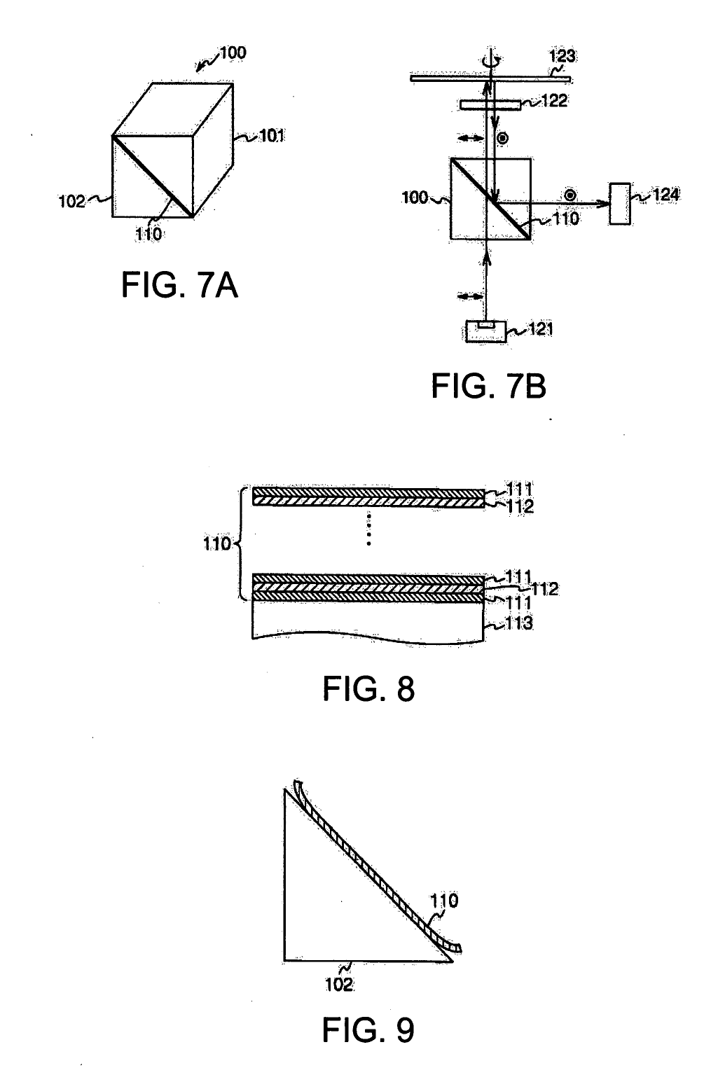

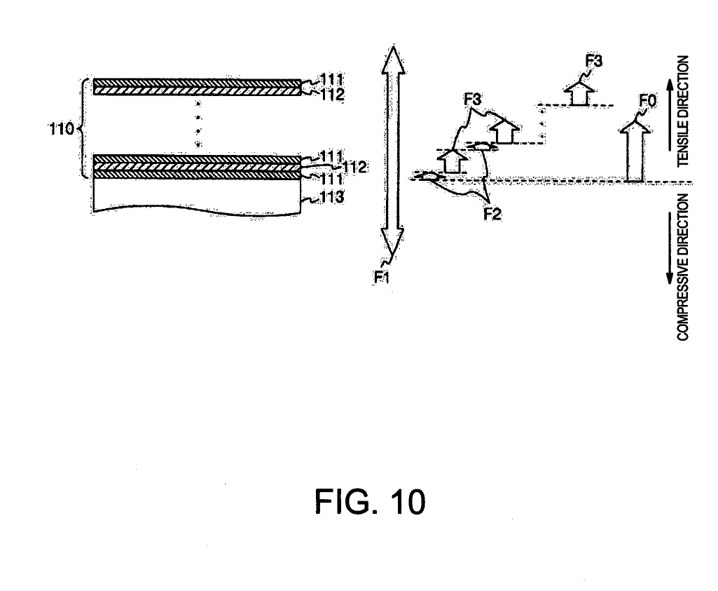

FIGS. 4A to 4D and FIGS. 5A to 5G are process views for illustrating the manufacturing method thereof. In those figures, left views are front longitudinal sectional views and right views are right side-surface views. In addition, FIG. 6 shows a flowchart of manufacturing processes, which corresponds to the views shown in FIGS. 4A to 4D and FIGS. 5A to 5G.

FIG. 4A shows a front view and a right side-surface view of a structure of the glass plate used in the manufacturing method according to the embodiment of the invention. The glass plate (planar optical member) 50 includes a polarized light splitting coating 52 formed on an upper surface of a rectangular glass sheet 51 having a uniformed thickness and a matching coating (ML coating) 53 formed on a lower surface thereof. The manufacturing method according to the embodiment uses a plurality of the glass plates 50 having completely the same structure as above. Steps 1 and 2 shown in FIG. 6 correspond to FIG. 4A and show processes for forming the polarized light splitting coating 52 and the matching coating 53 on upper and lower surfaces of the glass sheet 51, which are subjected to mirror surface finishing by polishing of the upper and lower surfaces thereof, respectively, as shown in step 2 of FIG. 6.

Furthermore, in the embodiment of the invention, when depositing the polarized light splitting coating 52, an ion-assist method is used to form the polarized light splitting coating having the structure as shown in FIG. 2. Specifically, the first polarized light splitting coating layer 10a is formed by alternately laminating the plurality of the lanthan-titanate coatings (high refractive index coatings) 11 as a high refractive index material and the plurality of the SiO₂ coatings (first low refractive index coating) 12 made of SiO₂ as the first low refractive index material, as well as the second polarized light splitting coating layer 10b is formed by alternately laminating the plurality of the MgF₂ coatings (second low refractive index coatings) 13 made of MgF₂ as a second low refractive index material and the plurality of the lanthan-titanate coatings (high refractive index coating) 11. As for the matching coating 53, when the plurality of glass plates 50 is bonded with the adhesive agent, it serves to prevent reflection of light occurring due to a difference in refractive indexes between the adhesive agent and the glass material, that is, a loss of light transmitting through the glass plate.

FIG. 4B illustrates a multilayer structure formation process in which the plurality of glass plates 50 is laminated at an inclined angle of approximately 45 degrees by using a jig 60. Specifically, the jig 60 includes a horizontally planar base 60a, an inclined sidewall 60b which is fixed inclining upwardly at the inclined angle of 45 degrees from the base 60a, etc. The glass plates 50 with the polarized light splitting coatings 52 on the upper surfaces thereof are sequentially laminated on the base 60a. In this situation, aligning one-side ends of the glass plates 50 along the inclined sidewall 60b allows a formation of a stepped multilayer structure 61 in which the glass plates 50 are displaced toward each surface direction thereof at each equal distance. In other words, the multilayer structure 61 has a front view of an approximately parallelogram shape. Before laminating the glass plates 50, a UV curable adhesive 62 is applied between the glass plates 50, and a pressure is applied to the multilayer structure 61 to uniformly spread the adhesive agent 62. In this situation, an ultraviolet ray is irradiated to the multilayer structure 61 from a not-shown UV light source to harden the adhesive agent 62 and bond the glass plates 50 to each other. FIG. 6-step 3 illustrates processes of the multilayer structure formation and bonding. As shown above, in the multilayer structure formation process, the plurality of rectangular glass plates 50 having the same structure are laminated via the UV adhesive 62, as well as the surface-direction positions of the individual glass plates are sequentially displaced and laminated in the stepped configuration such that an angle between a plane connecting ends of the glass plates 50 and the glass plate surfaces is the inclined angle of 45 degrees. In the bonding process, the glass plates 50 are bonded and fixed to each other.

FIG. 4C shows a cutting process for cutting the multilayer structure 61 integrated in the above bonding process at a plurality of parallel cut surfaces having a predetermined pitch along the above inclined angle of 45 degrees into a plurality of multilayer segments 65. FIG. 4C corresponds to steps 4 and 5 shown in FIG. 6. The multilayer structure 61 formed as shown in FIG. 4B is taken out from the jig 60 and a back side surface thereof is temporarily fixed onto a fixing plate 64 shown in FIG. 4C with a separatable adhesive or the like. After this, in the temporarily fixed state, the multilayer structure 61 is cut by a wire saw at equal intervals along cut lines 63 indicated by dotted lines. FIG. 4D shows multilayer segments 65 obtained by cutting the multilayer structure 61. Each cut line 63 is a line (or a surface) parallel to 45 degrees, which is the position displacement angle of the glass plates 50 forming the multilayer structure 61. The interval between the cut lines is determined according to the size and shape of a polarized light beam splitter intended as a finished product.

Next, as shown in FIG. 5A, mirror surface finishing is performed on upper and lower surfaces (cut surfaces) of the multilayer segments 65. After the mirror surface finishing, each of the surfaces thereof is coated with a reflection coating. Each of the multilayer segments 65, as shown in FIG. 5A has ends protruded at a sharp angle. Accordingly, when the above mirror surface finishing is performed, those parts may be destroyed and the debris of destroyed glass may be generated. The debris may enter a polishing member in a polishing apparatus, whereby the multilayer segment as an object to be polished may be damaged. Therefore, before the mirror surface finishing, the ends may be cut down in advance along cut lines 55. When cutting them down, as shown in step 5 of FIG. 6, after fixing the multilayer segments 65 laminated on a fixing portion 66a of a fixing jig 66, the sharp-angular ends of the multilayer segments 65 are collectively cut down. Then, as shown in step 6 of FIG. 6, after the mirror surface finishing is performed on the both surfaces, an anti-reflection (AR) coating is deposited thereon, as shown in step 7 of FIG. 6. The multilayer segments 65 are obtained by cutting the multilayer structure formed by bonding the glass plates 50 with the adhesive agent 62. Thus, each of the multilayer segments 65 has a structure formed by laminating the polarized light splitting coating 52, the glass sheet 51, the matching coating 53 and the adhesive agent 62 in this sequential order. Following this, as in the temporarily bonding process shown in FIG. 5B, the multilayer segments 65 are laminated in a consistent manner and temporarily bonded with paraffin 68 applied in advance between the multilayer segments 65. According to needs, a reinforcing plate composed of a flat glass plate is fixed on front and back surfaces of a laminated structure of the multilayer segments 65 with the UV curable adhesive 62 to prevent separation between the multilayer segments 65.

FIG. 5C illustrates a dividing process in which the plurality of multilayer segments 65 temporarily bonded with the paraffin 68 is cut by a wire saw along a cut surface 70 orthogonal to the cut surface 63 used in the above-described cutting process to form temporarily bonded multilayer structures 71. FIG. 5D illustrates a situation after the division by cutting.

FIG. 6-steps 8 and 9 correspond to the above process. As shown in those views, when cutting is performed, the reinforcing plate 67 is cut together. Thus, a part of the reinforcing plate 67 remains fixed to both ends of each temporarily-bonded multilayer structure 71. That is, the dividing process is a process for cutting the plurality of multilayer segments 65 temporarily bonded with the paraffin 68 at the cut surfaces 70 orthogonal to the cut surfaces used in the cutting process to form temporarily-bonded multilayer structures 71. Each temporarily-bonded multilayer structure 71 formed after the cutting along the cut lines 70 has a structure in which a plurality of completed polarized light beam splitters 1 is connected to each other via the paraffin 68 in a bar-like form. FIG. 5E shows a mirror surface finishing process for performing mirror surface finishing on the cut surfaces of the temporarily-bonded multilayer structures 71 obtained in the dividing process described above. After the mirror surface finishing, an anti-reflection (AR) coating is formed on the finished surfaces by deposition. Each temporarily-bonded multilayer structure 71 subjected to the surface coating with the AR coating is cut by a wire saw at cut lines 72 indicated by dotted lines. Each of the cut lines 72 is a line for cutting in a direction orthogonal to the cut surface formed by each cut line 70. FIG. 5F shows a connected structure 75 comprised of beam splitters, which are polarized light beam splitters obtained after cutting and separating along the cut lines 72. In the beam-splitter connected structure 75, still, individual polarized light beam splitters 1 remain connected to each other with the paraffin 68. FIG. 6-steps 10, 11 and 12 show the processes.

Next, FIG. 5G shows a separating process for separating each of the temporarily-bonded multilayer structures 71 left in the state as shown in FIG. 5F into individual polarized beam splitters 1 (FIG. 6-step 13) by dissolving the paraffin 68 by heating the multilayer structure 71 placed on a hot plate. In this manner, the yielding of the polarized light beam splitter 1 shown in FIG. 1 can be improved. Furthermore, in this case, when manufacturing a polarized light beam splitter by using a plurality of plate-like glass members, it is unnecessary to perform mirror surface finishing for polarized light beam splitters separated individually. Accordingly, the invention can provide the manufacturing method of the polarized light beam splitter with high productivity and practicability.

The foregoing detailed description has been given for clarity of understanding only and no unnecessary limitation should be understood therefrom, as various modifications of detail to the present invention will be apparent to those skilled in the art, all of which would come within the full spirit and scope of the invention.

What is claimed is:

1. A polarized light splitting device including two right triangular prisms bonded to each other at inclined surfaces thereof via a polarized light splitting coating disposed between the inclined surfaces;
the polarized light splitting coating comprising:
a first polarized light splitting coating layer formed by alternately laminating a first low refractive index coating made of a first low refractive index material having a compressive stress and a high refractive index coating made of a high refractive index material having a compressive stress; and
a second polarized light splitting coating layer formed by alternately laminating a second low refractive index coating made of a second low refractive index material having a tensile stress and the high refractive index coating.

2. The polarized light splitting device according to claim 1, wherein the first low refractive index coating is an SiO₂ coating and the second low refractive index coating is an MgF₂ coating.

3. A method for manufacturing a polarized light splitting device including two right triangular prisms bonded to each other at inclined surfaces thereof via a polarized light splitting coating disposed between the inclined surfaces, the method comprising:
preparing a plurality of rectangular glass plates, each having on its upper surface a polarized light splitting coating that includes a first polarized light splitting coating layer formed by alternately laminating a first low refractive index coating made of a first low refractive index material having a compressive stress and a high refractive index coating made of a high refractive index material having a compressive stress and a second polarized light splitting coating layer formed by alternately laminating a second low refractive index coating made of a second low refractive index material having a tensile stress and the high refractive index coating;
forming a multilayer structure by alternately laminating the plurality of glass plates via an adhesive material in a stepped configuration by sequentially displacing surface-direction positions of the glass plates such that an angle between a plane connecting ends of the glass plates and the glass plate surfaces is an inclined angle of approximately 45 degrees;
cutting the multilayer structure integrated in the multilayer structure formation process into a plurality of multilayer segments at a plurality of parallel cut surfaces having a predetermined pitch along the inclined angle of 45 degrees;
performing mirror surface finishing on the cut surfaces of the multilayer segments formed in the cutting process;
temporarily bonding the multilayer segments to each other with a temporarily bonding material by laminating them in a consistent manner such that the mirror surfaces of the multilayer segments obtained by segmentation in the cutting process are opposing to each other;
dividing the plurality of multilayer segments temporarily bonded with the temporarily bonding material by cutting the segments at cut surfaces orthogonal to the cut surfaces used in the cutting process to form temporarily bonded multilayer structures;
performing mirror surface finishing on the cut surfaces of the temporarily bonded multilayer structures obtained in the dividing process;
forming a connected structure comprised of a plurality of polarized light splitting devices which are connected in series via the temporarily bonding material by cutting each of the temporarily bonded multilayer structures in a direction orthogonal to the cut surfaces at equal intervals; and
separating the connected structure comprised of the polarized light splitting devices into individual cubic polarized light splitting devices by dissolving and removing the temporarily bonding material forming the connected structure.
